(19) United States
(12) Patent Application Publication
(10) Pub. No.: US 2022/0295816 A1
(43) Pub. Date: Sep. 22, 2022

(54) ENHANCED COFFEE OR TEA

(71) Applicant: Kirk Gibson Rummel, III, Austin, TX (US)

(72) Inventors: Kirk Gibson RUMMEL, III, Austin, TX (US); Kevin CHAPA, Austin, TX (US)

(21) Appl. No.: 17/612,767

(22) PCT Filed: May 19, 2020
(86) PCT No.: PCT/US2020/033520

§ 371 Date: Nov. 19, 2021

Related U.S. Application Data
(60) Provisional application No. 62/850,322, filed on May 20, 2019.
(60) Provisional application No. 62/862,197, filed on Jun. 17, 2019.
(60) Provisional application No. 62/867,070, filed on Jun. 26, 2019.
(60) Provisional application No. 62/873,708, filed on Jul. 12, 2019.

(51) Int. Cl. A23F 5/26; A23F 5/42

(52) U.S. Cl. CPC A23F 5/267; A23F 5/42

(57) ABSTRACT

A compound capable of adjusting a concentration of magnesium or calcium dissolved in water, and coffee or tea in dry form are packaged in a container, for example, to form single-serve capsules or pods. Alternatively, a composition is made by adding the compound to the coffee or tea in dry form. The container holding the compound and the coffee or tea in dry form, and the composition made by adding the compound to the coffee or tea in dry form are used for brewing a caffeinated drink.

### CROSS-REFERENCE TO RELATED APPLICATIONS

This application claims the benefit of priority to U.S. provisional application Ser. No. 62/850,322, filed on May 20, 2019, U.S. provisional application Ser. No. 62/862,197, filed on Jun. 17, 2019, U.S. provisional application Ser. No. 62/867,070, filed on Jun. 26, 2020, and U.S. provisional application Ser. No. 62/873,708, filed on Jul. 12, 2019. All the priority applications are hereby incorporated by reference for all and any purposes.

### BACKGROUND

This disclosure relates generally to methods and apparatus for improving the flavor of caffeinated drinks, such as roasted whole-bean, roasted ground coffee, instant coffee, or tea and improving the flavor and reducing perceived acidity of coffee or tea brewed in single-serve capsules or pods.

Many standard filtration systems at home or in commercial settings will filter out a few of the minerals occurring in tap water, and for the minerals that may remain, it is unlikely that they are a desirable composition and mass for coffee brewing.

Enhancing the water used to brew coffee with compounds containing magnesium and/or calcium, free of their bases or clays (potentially aluminum silicate), is a common practice in coffee shops and a known practice for brewing coffee elsewhere. These minerals are usually added to the water by mineralizers in coffee shops or in mixture packets for the brewing water at home.

More applicable to single-serve capsules or pods, the sweet and bitter flavors of coffee, and their unique chemical compositions, are mostly released late (after 75 seconds) in brew processes that have standard or extended brew time, typically a standard brew time for coffee is several minutes. When the brew time is short (less than 75 seconds) compared to the standard or extended brew times, the sugars or bitter flavors in the coffee do not have enough time to be released as they would be during standard or more extended brew times. Thus, short brew times typical of single-serve capsules or pods lead to a stronger acidic taste of the brewed coffee. Magnesium and/or calcium are effective at reducing the perceived acidity caused by short brew times. When present in a sufficient amount, these minerals produce a noticeably smoother cup of coffee.

Single-serve capsules or pods have filters that allow for a high flow rate. Thus, coffee packaged in these capsules or pods brews quickly, typically in less than 75 seconds. Accordingly, coffee brewed in single-serve capsules or pods leads to increased perceived acidity in the brewed coffee.

Thus, there is a continuing need in the art for methods and apparatus for conveniently and affordably improving the flavor of coffee, and more specifically for single-serve capsules or pods, reducing the perceived acidity of coffee due to the short brew time.

### SUMMARY

The disclosure describes a composition for brewing a caffeinated drink.

The composition may comprise coffee or tea in dry form. For example, the coffee or tea in dry form includes at least one of ground, whole-bean, or instant coffee. Alternatively, the coffee or tea in dry form includes at least one of shredded tea leaves, whole tea leaves, or instant tea.

The composition may comprise a compound capable of adjusting a concentration of magnesium or calcium dissolved in water. The compound may be added to the coffee or tea in dry form in an amount sufficient for improving the taste of the caffeinated drink.

In some embodiments, the compound includes at least one of a water-soluble salt of magnesium or a water-soluble salt of calcium.

In some embodiments, the compound is capable of generating hydroxide ions or carbonate ions in water.

The disclosure also describes an article usable for brewing a caffeinated drink. The article may comprise a container for holding coffee or tea in dry form and a compound capable of adjusting a concentration of magnesium or calcium dissolved in water. The compound may be in an amount sufficient for improving the taste of the caffeinated drink.

In some embodiments, the container may comprise a filter in which the coffee or tea in dry form may be placed. The compound may also be placed inside the filter, or the filter may be impregnated with the compound.

In some embodiments, the container may further comprise an exterior layer surrounding the filter, and the coffee or tea in dry form may be placed inside the filter. The compound may be placed inside the filter, or the filter may be impregnated with the compound, or the compound may be placed between the filter and the exterior layer.

In some embodiments, the container may comprise a capsule and a compartment. The compound may be placed inside the compartment, and the coffee or tea in dry form may be placed inside the capsule. The compartment may be placed above or below the capsule.

In some embodiments, the container may comprise a capsule and a packet. The compound may be placed inside the packet, and the coffee or tea in dry form may be placed inside the capsule. The packet may be placed inside the capsule.

In some embodiments, the compound may be mixed with the coffee or tea in dry form, and a mixture of the compound with the coffee or tea in dry form may be placed in the container.

The disclosure also describes a method of brewing a caffeinated drink.

The method may comprise the steps of providing the composition as described hereinabove and adding water to the composition.

The method may alternatively comprise the steps of providing the article as described hereinabove and causing water to pass through the container.

### DETAILED DESCRIPTION

The methods and apparatus disclosed herein involve mixing water-soluble salts containing magnesium and/or calcium with coffee that may be packaged in a capsule or pod. The coffee will have the mixture containing magnesium and/or calcium enclosed in such a manner that the water-soluble salts containing magnesium and/or calcium will mix with the water and/or brewed coffee when the capsule or pod is brewed. Mixing magnesium and/or calcium directly with the coffee, instead of with the water, provides a convenient and affordable method and composition for flavor enhancement of coffee. It also avoids mixing the minerals by hand into the water at home or installing expensive water mineralizers to improve flavor.

A capsule or pod in accordance with a preferred embodiment includes a container having a filter or may be the filter itself, and may also contain an exterior layer made of plastic or metal that make up the capsule or pod. The container also comprises coffee, a compound including magnesium and/or calcium. As used herein, coffee means ground, whole-bean, or instant coffee. The capsule or pod may be sized as a single-serve capsule or pod. The container may include an exterior plastic and/or metal layer and a filter layer. The coffee may be placed inside the filter layer.

In some embodiments, the compound may consist of the water-soluble salts containing magnesium and/or calcium or may consist of elemental magnesium and/or calcium. In other embodiments, the compound may further comprise additional substances, for example, any base, whether dry or liquid, that does not excessively inhibit flow rate through the filter, and/or does not excessively affect the standard ratios of coffee to water that is used with brewing. For example, the compound has preferably been manufactured by completely or partially separating the water-soluble salts containing magnesium and/or calcium from their naturally occurring substance (e.g., clay, mud, etc.). Any compound, or mixture of compounds, containing magnesium and/or calcium, that facilitates or accelerates the dissolution of the coffee flavors and/or improves the taste by its presence in final brewed coffee, especially in the fast brew settings like capsules or pods, may be used.

In some embodiments, the compound can be dispersed in the coffee. For example, the compound can be added before or after the roasting process and mixed thoroughly with either unroasted coffee, roasted ground, roasted whole-bean, or instant coffee. In other embodiments, the compound can be added to the coffee in the production process without being thoroughly mixed into the coffee. In yet other embodiments, the filter is impregnated with the compound. The filter may comprise one or more layers. In other embodiments specifically for single-serve capsule or pod applications, the compound may be placed inside the exterior plastic and/or metal layer, and outside the filter. For example, the compound may be applied to an inner surface of the exterior plastic layer and/or metal. In other embodiments specifically for single-serve capsule or pod applications, there may be a separate compartment above or below the exterior of the capsule or pod, the compartment containing the compound. The compartment will puncture or dissolve when the capsule or pod is prepared to be brewed or brewed. Accordingly, the compound can be quickly dissolved in the water.

Alternatively, a packet containing an amount compound suitable for one capsule or pod may be provided with (e.g., attached to) each capsule or pod. For example, the packet may form a compartment within the capsule or pod. The packet may be dissolvable in water when the packet is brewed, or may be punctured before or while the packet is brewed.

A packet containing an amount compound suitable for a given quantity of coffee, intended to be mixed directly with coffee by the consumer, may be provided to consumers.

Preferably, the compound is formulated and added to the coffee such that there is at least 0.025 grams of elemental magnesium and 0.025 grams of elemental calcium per pound of coffee (in any form, including any salt). It is believed that someone could detect the difference in taste at these concentrations. Accordingly, at least 0.025 grams of elemental magnesium per pound of coffee (or tea) constitutes an amount sufficient for improving a taste of a caffeinated drink. Similarly, at least 0.025 grams of elemental calcium per pound of coffee (or tea) constitutes another amount sufficient for improving a taste of the caffeinated drink. Depending on the mineral content of the water being used to brew the coffee, and the type of filter, if any, being used, the compound is preferably formulated and added to the coffee such that there is up to 0.15 grams (+/−80%, and preferably +/−40%) of elemental magnesium per pound of coffee and 0.05 grams (+/−50%, and preferably +/−25%) of elemental calcium per pound of coffee. In some cases, the preferable concentration may be even higher, depending on consumer preference, up to 0.75 grams of elemental magnesium or elemental calcium per pound of coffee.

Additionally, it is known that the concentrations of both calcium and magnesium present in home water can vary greatly based on where people live and how they filter their water. While it is ideal for adding magnesium and/or calcium when low concentrations of magnesium and/or calcium and are present, it may be preferable to add a mineral and/or compound containing a hydroxide and/or carbonate ion if there are high concentrations of magnesium and/or calcium already present in the water used for brewing. Without being limited to any theory, the hydroxide and/or carbonate can bond with magnesium and/or calcium, precipitate, and reduce the unpleasant bite associated with water containing undesirably high magnesium and/or calcium concentrations, also known as hard water. While the optimal ratios of hydroxide and/or carbonate molecules are heavily dependent on the preexisting calcium and/or magnesium content of the water being used to brew the coffee, and the type of filter, if any, being used, the hydroxide and/or carbonate compound is preferably formulated and added to the coffee such that there is approximately, cumulatively, 0.3 grams (+/−80%, and preferably +/−40%) of molecular hydroxide and/or carbonate per pound of coffee. The preferable concentration in some cases may be even higher depending on consumer preference, up to cumulatively 1.5 grams of molecular hydroxide and/or carbonate per pound of coffee. The hydroxide and/or carbonate compound is formulated and added to the coffee so that there is at least 0.025 grams of molecular hydroxide and 0.025 grams of molecular carbonate per pound of coffee (in any form, including any salt). Below this point, it is not thought that the hydroxide and/or carbonate compound would be detected. Accordingly, at least 0.025 grams of molecular hydroxide per pound of coffee (or tea) constitutes yet another amount sufficient for improving a taste of a caffeinated drink. Similarly, at least 0.025 grams per pound of coffee (or tea) of molecular carbonate constitutes still yet another amount sufficient for improving a taste of the caffeinated drink. In some cases, the molecular hydroxide and/or carbonate compounds may be added with or without any magnesium and/or calcium compounds to enhance flavor by balancing the mineral concentrations.

In some embodiments, the compound may comprise magnesium sulfate and calcium citrate. However, other magnesium and/or calcium salts may be used instead of magnesium sulfate and calcium citrate. Further, the compound may comprise the magnesium sulfate and calcium citrate as well as additional substances that do not excessively inhibit flow rate through the filter and/or do not excessively affect the standard ratios of coffee to water that is used with brewing.

The process, article, and composition described herein can provide affordable and convenient means for consumers to brew mineral enhanced coffee for the purpose of flavor enhancement, most acutely for single-serve capsule or pod applications where there is an increased perceived acidity in the absence of the compound.

Furthermore, it should be appreciated that similar processes, articles, and compounds can also provide affordable and convenient means for consumers to brew mineral enhanced tea for the purpose of flavor enhancement, in particular for single-serve capsule or pod applications.

Specific embodiments of the invention have been disclosed. It should be understood, however, that the detailed description is not intended to limit the invention to the particular form disclosed, but on the contrary, the intention is to cover all modifications, equivalents, and alternatives falling within the scope of the claims.

What is claimed is:

1. A composition for brewing a caffeinated drink, comprising:
a compound capable of adjusting a concentration of magnesium or calcium dissolved in water; and
coffee or tea in dry form,
wherein the compound is added to the coffee or tea in dry form in an amount sufficient for improving a taste of the caffeinated drink.

2. The composition of claim 1, wherein the coffee or tea in dry form includes at least one of ground, whole-bean, or instant coffee.

3. The composition of claim 1, wherein the coffee or tea in dry form includes at least one of shredded tea leaves, whole tea leaves, or instant tea.

4. The composition of claim 1, wherein the compound is further mixed with the coffee or tea in dry form.

5. The composition of claim 1, wherein the compound includes at least one of a water-soluble salt of magnesium or a water-soluble salt of calcium.

6. The composition of claim 5, wherein the compound includes magnesium sulfate.

7. The composition of claim 5, wherein the compound includes calcium citrate.

8. The composition of claim 1, wherein a concentration of elemental magnesium or calcium in the composition is between 0.025 grams per pound of coffee or tea in dry form and 0.75 grams per pound of coffee or tea in dry form.

9. The composition of claim 8, wherein the concentration of elemental magnesium is 0.15 grams per pound of coffee or tea in dry form, +/−80 percent.

10. The composition of claim 9, wherein the concentration of elemental magnesium is 0.15 grams per pound of coffee or tea in dry form, +/−40 percent.

11. The composition of claim 8, wherein the concentration of elemental calcium is 0.05 grams per pound of coffee or tea in dry form, +/−80 percent.

12. The composition of claim 11, wherein the concentration of elemental calcium is 0.05 grams per pound of coffee or tea in dry form, +/−40 percent.

13. The composition of claim 1, wherein the compound is capable of generating hydroxide ions or carbonate ions in water.

14. The composition of claim 1, wherein the compound is capable of generating between 0.025 grams per pound coffee or tea in dry form and 1.5 grams per pound coffee or tea in dry form of molecular hydroxide or carbonate in water.

15. The composition of claim 14, wherein the compound is capable of generating 0.3 grams per pound coffee or tea in dry form of cumulated molecular hydroxide and carbonate in water, +/−80 percent.

16. The composition of claim 15, wherein the compound is capable of generating 0.3 grams per pound coffee or tea in dry form of cumulated molecular hydroxide and carbonate in water, +/−40 percent.

17. An article usable for brewing a caffeinated drink, the article comprising a container holding:
a compound capable of adjusting a concentration of magnesium or calcium dissolved in water; and
coffee or tea in dry form,
wherein an amount of the compound is sufficient for improving a taste of the caffeinated drink.

18. The article of claim 17, wherein the container consists of a filter permeable to water.

19. The article of claim 17, wherein the container comprises a filter permeable to water, and the filter is impregnated with the compound.

20. The article of claim 17, wherein the container comprises a filter and an exterior layer surrounding the filter.

21. The article of claim 20, wherein the compound is placed inside the exterior layer and outside the filter.

22. The article of claim 17, wherein the container comprises a compartment and a capsule, wherein the compound is placed inside the compartment, and wherein the coffee or tea in dry form is placed inside the capsule.

23. The article of claim 22, wherein the compartment is dissolvable in water or can be punctured.

24. The article of claim 17, wherein the container comprises a packet and a capsule, wherein the compound is placed inside the packet, and wherein the coffee or tea in dry form is placed inside the capsule.

25. The article of claim 24, wherein the packet is located inside the capsule.

26. The article of claim 24, wherein the packet is attached to the capsule.

27. The article of claim 17, wherein the compound is further mixed with the coffee or tea in dry form, and wherein a mixture of the compound with the coffee or tea in dry form is located inside the container.

28. A method of brewing a caffeinated drink, comprising:
providing the composition of any of claims 1-16; and
adding water to the composition.

29. A method of brewing a caffeinated drink, comprising:
providing the article of any of claims 17-27; and
causing water to pass through the container.
